(19) United States
(12) Patent Application Publication
(10) Pub. No.: US 2021/0350303 A1
(43) Pub. Date: Nov. 11, 2021

(54) TASK LIST FOR TASKS CREATED AT A THIRD-PARTY SOURCE

(71) Applicant: Dropbox, Inc., San Francisco, CA (US)

(72) Inventors: Walid Omar, San Francisco, CA (US); Charlotte Ziob, San Francisco, CA (US); Abhinav Garg, San Francisco, CA (US); Andrew Haven, San Francisco, CA (US); Yael Keren, Nordia (IL); Alexandru Grigoras, San Francisco, CA (US); Jacqueline T. Lin, San Jose, CA (US); Walter Somerville, San Francisco, CA (US); John Nicholas Jitkoff, Palo Alto, CA (US)

(21) Appl. No.: 16/932,271

(22) Filed: Jul. 17, 2020

Related U.S. Application Data
(60) Provisional application No. 63/021,767, filed on May 8, 2020.

(51) Int. Cl. G06Q 10/06; G06Q 10/10

(52) U.S. Cl. CPC G06Q 10/06316; G06Q 10/103; G06Q 10/1097

(57) ABSTRACT

The present technology addresses a need for a task service that can aggregate tasks assigned to a user on different services so that all tasks that the user needs to perform can be found in one location. The present technology can utilize credentials to a user account associated with a user of a service to automatically identify tasks that are relevant to the user and can create those tasks in a task service. The task service can maintain a link back to the source of the task so that the user can mark the task as complete in the task service, and the task service can automatically update the task in the service in which the task was created. The present technology can also provide integrations with some services to a user to create new tasks from services that are not task based, such as email.

### CROSS REFERENCE TO RELATED APPLICATIONS

This application claims the benefit of and/or priority to U.S. provisional application No. 63/021,767, entitled “TASK LIST FOR TASKS CREATED AT A THIRD-PARTY SOURCE,” filed on May 8, 2020, which is expressly incorporated by reference herein in its entirety.

### TECHNICAL FIELD

The present technology pertains to providing a task list of tasks created at a third-party source, and more specifically pertains to repeated communication between the task list and the third-party sources to keep a task list and the third-party sources up to date with the latest updates to the task.

### BACKGROUND

People utilize many different services to perform their job functions. For example, people might utilize email, a workspaces service, a task service, a chat service, a document management service, etc. In fact, people might even use multiple services that provide overlapping functionalities because modern workers often work across multiple teams that could use different sets of services. Frequently, a person might find themselves having tasks assigned to them across many of these services, and switching between these services to find and manage tasks is time consuming.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of a content management system and client devices in accordance with some aspects of the present technology;

FIG. 2 illustrates an example embodiment of a task service along with at least two mechanisms of interaction with third-party services in accordance with some aspects of the present technology;

FIG. 3 illustrates an example method embodiment for creating and managing tasks by the task service in accordance with some aspects of the present technology;

FIG. 4A and FIG. 4B illustrate an example graphical user interface presented by task service 136 and features thereof in accordance with some aspects of the present technology;

FIG. 5A illustrates an example embodiment of a graphical user interface receiving a modification to the task at a task service;

FIG. 5B illustrates that the modification illustrated in FIG. 5A can become automatically reflected in the task at the third-party service in accordance with some aspects of the present technology;

FIG. 6 illustrates an example embodiment of a task creation interface in accordance with some aspects of the present technology;

FIG. 7 illustrates some example method embodiments for making managing tasks easier in accordance with some aspects of the present technology; and

FIG. 8 shows an example of a system embodiment for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a task service that can aggregate tasks assigned to a user on different services so that all tasks that the user needs to perform can be found in one location. People utilize many different services to perform their job functions. For example, people might utilize email, a workspaces service, a task service, a chat service, a document management service, etc. In fact, people might even use multiple services that provide overlapping functionalities because modern workers often work across multiple teams that could use different sets of services. Frequently, a person might find themselves having tasks assigned to them across many of these services, and switching between these services to find and manage tasks is time consuming. The present technology allows teams to continue to interact in the services that they are accustomed to, but at the same time provides a single task list for a specific user.

In some embodiments, the present technology can utilize credentials to a user account associated with a user of a service to automatically identify tasks that are relevant to the user and can create those tasks in a task service. In some embodiments, the task service can maintain a link back to the source of the task so that the user can mark the task as complete in the task service, and the task service can automatically update the task in the service in which the task was created. In some embodiments, the link back to the source of the task can also be used to allow the user to efficiently navigate to the source of the task without having to remember the source and try to locate it. In some embodiments, the present technology can also provide integrations with some services to a user to create new tasks from services that are not task based, such as email.

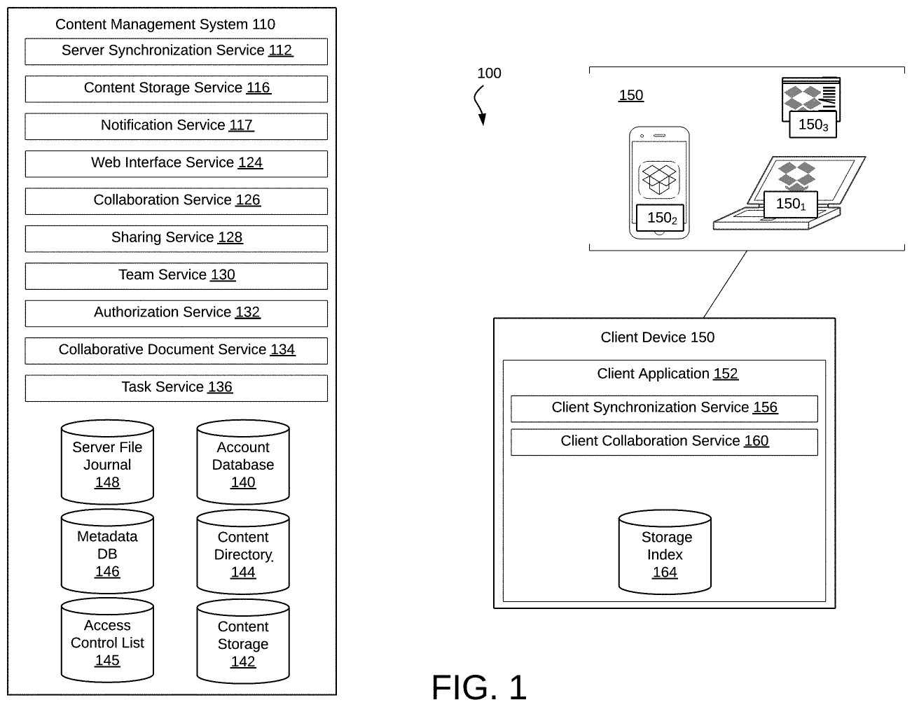

In some embodiments the disclosed technology is deployed in the context of a content management system having content item synchronization capabilities and collaboration features, among others. An example system configuration 100 is shown in FIG. 1, which depicts content management system 110 interacting with client device 150.

Accounts

Content management system 110 can store content items in association with accounts, as well as perform a variety of content item management tasks, such as retrieve, modify, browse, and/or share the content item(s). Furthermore, content management system 110 can enable an account to access content item(s) from multiple client devices.

Content management system 110 supports a plurality of accounts. An entity (user, group of users, team, company, etc.) can create an account with content management system, and account details can be stored in account database 140. Account database 140 can store profile information for registered entities. In some cases, profile information for registered entities includes a username and/or email address. Account database 140 can include account management information, such as account type (e.g. various tiers of free or paid accounts), storage space allocated, storage space used, client devices 150 having a registered content management client application 152 resident thereon, security settings, personal configuration settings, etc.

Account database 140 can store groups of accounts associated with an entity. Groups can have permissions based on group policies and/or access control lists, and members of the groups can inherit the permissions. For example, a marketing group can have access to one set of content items while an engineering group can have access to another set of content items. An administrator group can modify groups, modify user accounts, etc.

Content Item Storage

A feature of content management system 110 is the storage of content items, which can be stored in content storage 142. Content items can be any digital data such as documents, collaboration content items, text files, audio files, image files, video files, webpages, executable files, binary files, etc. A content item can also include collections or other mechanisms for grouping content items together with different behaviors, such as folders, zip files, playlists, albums, etc. A collection can refer to a folder, or a plurality of content items that are related or grouped by a common attribute. In some embodiments, content storage 142 is combined with other types of storage or databases to handle specific functions. Content storage 142 can store content items, while metadata regarding the content items can be stored in metadata database 146. Likewise, data regarding where a content item is stored in content storage 142 can be stored in content directory 144. Additionally, data regarding changes, access, etc. can be stored in server file journal 148. Each of the various storages/databases such as content storage 142, content directory 144, server file journal 148, and metadata database 146 can be comprised of more than one such storage or database and can be distributed over many devices and locations. Other configurations are also possible. For example, data from content storage 142, content directory 144, server file journal 148, and/or metadata database 146 may be combined into one or more content storages or databases or further segmented into additional content storages or databases. Thus, content management system 110 may include more or less storages and/or databases than shown in FIG. 1.

In some embodiments, content storage 142 is associated with at least one content storage service 116, which includes software or other processor executable instructions for managing the storage of content items including, but not limited to, receiving content items for storage, preparing content items for storage, selecting a storage location for the content item, retrieving content items from storage, etc. In some embodiments, content storage service 116 can divide a content item into smaller chunks for storage at content storage 142. The location of each chunk making up a content item can be recorded in content directory 144. Content directory 144 can include a content entry for each content item stored in content storage 142. The content entry can be associated with a unique ID, which identifies a content item.

In some embodiments, the unique ID, which identifies a content item in content directory 144, can be derived from a deterministic hash function. This method of deriving a unique ID for a content item can ensure that content item duplicates are recognized as such since the deterministic hash function will output the same identifier for every copy of the same content item, but will output a different identifier for a different content item. Using this methodology, content storage service 116 can output a unique ID for each content item.

Content storage service 116 can also designate or record a content path for a content item in metadata database 146. The content path can include the name of the content item and/or folder hierarchy associated with the content item. For example, the content path can include a folder or path of folders in which the content item is stored in a local file system on a client device. While content items are stored in content storage 142 in blocks and may not be stored under a tree like directory structure, such directory structure is a comfortable navigation structure for users. Content storage service 116 can define or record a content path for a content item wherein the “root” node of a directory structure can be a namespace for each account. Within the namespace can be a directory structure defined by a user of an account and/or content storage service 116. Metadata database 146 can store the content path for each content item as part of a content entry.

In some embodiments the namespace can include additional namespaces nested in the directory structure as if they are stored within the root node. This can occur when an account has access to a shared collection. Shared collections can be assigned their own namespace within content management system 110. While some shared collections are actually a root node for the shared collection, they are located subordinate to the account namespace in the directory structure, and can appear as a folder within a folder for the account. As addressed above, the directory structure is merely a comfortable navigation structure for users, but does not correlate to storage locations of content items in content storage 142.

While the directory structure in which an account views content items does not correlate to storage locations at content management system 110, the directory structure can correlate to storage locations on client device 150 depending on the file system used by client device 150.

As addressed above, a content entry in content directory 144 can also include the location of each chunk making up a content item. More specifically, the content entry can include content pointers that identify the location in content storage 142 of the chunks that make up the content item.

In addition to a content path and content pointer, a content entry in content directory 144 can also include a user account identifier that identifies the user account that has access to the content item and/or a group identifier that identifies a group with access to the content item and/or a namespace to which the content entry belongs.

Content storage service 116 can decrease the amount of storage space required by identifying duplicate content items or duplicate blocks that make up a content item or versions of a content item. Instead of storing multiple copies, content storage 142 can store a single copy of the content item or block of the content item and content directory 144 can include a pointer or other mechanism to link the duplicates to the single copy.

Content storage service 116 can also store metadata describing content items, content item types, folders, file path, and/or the relationship of content items to various accounts, collections, or groups in metadata database 146, in association with the unique ID of the content item.

Content storage service 116 can also store a log of data regarding changes, access, etc. in server file journal 148. Server file journal 148 can include the unique ID of the content item and a description of the change or access action along with a time stamp or version number and any other relevant data. Server file journal 148 can also include pointers to blocks affected by the change or content item access. Content storage service can provide the ability to undo operations, by using a content item version control that tracks changes to content items, different versions of content items (including diverging version trees), and a change history that can be acquired from the server file journal 148.

Content Item Synchronization

Another feature of content management system 110 is synchronization of content items with at least one client device 150. Client device(s) can take different forms and have different capabilities. For example, client device 150₁ is a computing device having a local file system accessible by multiple applications resident thereon. Client device 150₂ is a computing device wherein content items are only accessible to a specific application or by permission given by the specific application, and the content items are typically stored either in an application specific space or in the cloud. Client device 150₃ is any client device accessing content management system 110 via a web browser and accessing content items via a web interface. While example client devices 150₁, 150₂, and 150₃ are depicted in form factors such as a laptop, mobile device, or web browser, it should be understood that the descriptions thereof are not limited to devices of these example form factors. For example a mobile device such as client 150₂ might have a local file system accessible by multiple applications resident thereon, or client 150₂ might access content management system 110 via a web browser. As such, the form factor should not be considered limiting when considering client 150's capabilities. One or more functions described herein with respect to client device 150 may or may not be available on every client device depending on the specific capabilities of the device—the file access model being one such capability.

In many embodiments, client devices are associated with an account of content management system 110, but in some embodiments, client devices can access content using shared links and do not require an account.

As noted above, some client devices can access content management system 110 using a web browser. However, client devices can also access content management system 110 using client application 152 stored and running on client device 150. Client application 152 can include a client synchronization service 156.

Client synchronization service 156 can be in communication with server synchronization service 112 to synchronize changes to content items between client device 150 and content management system 110.

Client device 150 can synchronize content with content management system 110 via client synchronization service 156. The synchronization can be platform agnostic. That is, content can be synchronized across multiple client devices of varying type, capabilities, operating systems, etc. Client synchronization service 156 can synchronize any changes (new, deleted, modified, copied, or moved content items) to content items in a designated location of a file system of client device 150.

Content items can be synchronized from client device 150 to content management system 110, and vice versa. In embodiments wherein synchronization is from client device 150 to content management system 110, a user can manipulate content items directly from the file system of client device 150, while client synchronization service 156 can monitor directory on client device 150 for changes to files within the monitored folders.

When client synchronization service 156 detects a write, move, copy, or delete of content in a directory that it monitors, client synchronization service 156 can synchronize the changes to content storage service 116. In some embodiments, client synchronization service 156 can perform some functions of content storage service 116 including functions addressed above such as dividing the content item into blocks, hashing the content item to generate a unique identifier, etc. Client synchronization service 156 can index content within client storage index 164 and save the result in storage index 164. Indexing can include storing paths plus a unique server identifier, and a unique client identifier for each content item. In some embodiments, client synchronization service 156 learns the unique server identifier from server synchronization service 112, and learns the unique client identifier from the operating system of client device 150. ,

Client synchronization service 156 can use storage index 164 to facilitate the synchronization of at least a portion of the content within client storage with content associated with a user account on content management system 110. For example, client synchronization service 156 can compare storage index 164 with content management system 110 and detect differences between content on client storage and content associated with a user account on content management system 110. Client synchronization service 156 can then attempt to reconcile differences by uploading, downloading, modifying, and deleting content on client storage as appropriate. Content storage service 116 can store the changed or new block for the content item and update server file journal 148, metadata database 146, content directory 144, content storage 142, account database 140, etc. as appropriate.

When synchronizing from content management system 110 to client device 150, a mount, modification, addition, deletion, move of a content item recorded in server file journal 148 can trigger a notification to be sent to client device 150 using notification service 117. When client device 150 is informed of the change a request changes listed in server file journal 148 since the last synchronization point known to the client device. When client device 150 determines that it is out of synchronization with content management system 110, client synchronization service 156 requests content item blocks including the changes, and updates its local copy of the changed content items.

In some embodiments, storage index 164 stores tree data structures wherein one tree reflects the latest representation of a directory according to server synchronization service 112, while another tree reflects the latest representation of the directory according to client synchronization service 156. Client synchronization service can work to ensure that the tree structures match by requesting data from server synchronization service 112 or committing changes on client device 150 to content management system 110.

Sometimes client device 150 might not have a network connection available. In this scenario, client synchronization service 156 can monitor the linked collection for content item changes and queue those changes for later synchronization to content management system 110 when a network connection is available Similarly, a user can manually start, stop, pause, or resume synchronization with content management system 110.

Client synchronization service 156 can synchronize all content associated with a particular user account on content management system 110. Alternatively, client synchronization service 156 can selectively synchronize a portion of the content of the total content associated with the particular user account on content management system 110. Selectively synchronizing only a portion of the content can preserve space on client device 150 and save bandwidth.

In some embodiments, client synchronization service 156 selectively stores a portion of the content associated with the particular user account and stores placeholder content items in client storage for the remainder portion of the content. For example, client synchronization service 156 can store a placeholder content item that has the same filename, path, extension, metadata, of its respective complete content item on content management system 110, but lacking the data of the complete content item. The placeholder content item can be a few bytes or less in size while the respective complete content item might be significantly larger. After client device 150 attempts to access the content item, client synchronization service 156 can retrieve the data of the content item from content management system 110 and provide the complete content item to accessing client device 150. This approach can provide significant space and bandwidth savings while still providing full access to a user's content on content management system 110.

Collaboration Features

Another feature of content management system 110 is to facilitate collaboration between users. Collaboration features include content item sharing, commenting on content items, co-working on content items, instant messaging, providing presence and seen state information regarding content items, etc.

Sharing

Content management system 110 can manage sharing content via sharing service 128. Sharing content by providing a link to the content can include making the content item accessible from any computing device in network communication with content management system 110. However, in some embodiments a link can be associated with access restrictions enforced by content management system 110 and access control list 145. Sharing content can also include linking content using sharing service 128 to share content within content management system 110 with at least one additional user account (in addition to the original user account associated with the content item) so that each user account has access to the content item. The additional user account can gain access to the content by accepting the content, which will then be accessible through either web interface service 124 or directly from within the directory structure associated with their account on client device 150. The sharing can be performed in a platform agnostic manner. That is, the content can be shared across multiple client devices 150 of varying type, capabilities, operating systems, etc. The content can also be shared across varying types of user accounts.

To share a content item within content management system 110 sharing service 128 can add a user account identifier or multiple user account identifiers to a content entry in access control list database 145 associated with the content item, thus granting the added user account access to the content item. Sharing service 128 can also remove user account identifiers from a content entry to restrict a user account's access to the content item. Sharing service 128 can record content item identifiers, user account identifiers given access to a content item, and access levels in access control list database 145. For example, in some embodiments, user account identifiers associated with a single content entry can specify different permissions for respective user account identifiers with respect to the associated content item.

To share content items outside of content management system 110, sharing service 128 can generate a custom network address, such as a uniform resource locator (URL), which allows any web browser to access the content item or collection in content management system 110 without any authentication. To accomplish this, sharing service 128 can include content identification data in the generated URL, which can later be used to properly identify and return the requested content item. For example, sharing service 128 can include the account identifier and the content path or a content item identifying code in the generated URL. Upon selection of the URL, the content identification data included in the URL can be transmitted to content management system 110, which can use the received content identification data to identify the appropriate content item and return the content item.

In addition to generating the URL, sharing service 128 can also be configured to record in access control list database 145 that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing service 128 can change the value of the flag to 1 or true after generating a URL to the content item.

In some embodiments, sharing service 128 can associate a set of permissions to a URL for a content item. For example, if a user attempts to access the content item via the URL, sharing service 128 can provide a limited set of permissions for the content item. Examples of limited permissions include restrictions that the user cannot download the content item, save the content item, copy the content item, modify the content item, etc. In some embodiments, limited permissions include restrictions that only permit a content item to be accessed from with a specified domain, i.e., from within a corporate network domain, or by accounts associated with a specified domain, e.g., accounts associated with a company account (e.g., @acme.com).

In some embodiments, sharing service 128 can also be configured to deactivate a generated URL. For example, each content entry can also include a URL active flag indicating whether the content should be returned in response to a request from the generated URL. For example, sharing service 128 can only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing service 128 can reactivate the URL by again changing the value of the URL active flag to 1 or true. A user can thus easily restore access to the content item without the need to generate a new URL.

In some embodiments, content management system 110 can designate a URL for uploading a content item. For example, a first user with a user account can request such a URL, provide the URL to a contributing user and the contributing user can upload a content item to the first user's user account using the URL.

Team Service

In some embodiments content management system 110 includes team service 130. Team service 130 can provide functionality for creating and managing defined teams of user accounts. Teams can be created for a company, with sub-teams (e.g., business units, or project teams, etc.), and user accounts assigned to teams and sub-teams, or teams can be created for any defined group of user accounts. Teams service 130 can provide a common shared space for the team, private user account folders, and access limited shared folders. Teams service can also provide a management interface for an administrator to manage collections and content items within team, and can manage user accounts that are associated with the team.

Authorization Service

In some embodiments, content management system 110 includes authorization service 132. Authorization service 132 ensures that a user account attempting to access a namespace has appropriate rights to access the namespace. Authorization service 132 can receive a token from client application 152 that follows a request to access a namespace and can return the capabilities permitted to the user account. For user accounts with multiple levels of access (e.g. a user account with user rights and administrator rights), authorization service 132 can also require explicit privilege escalation to avoid unintentional actions by administrators.

Presence and Seen State

In some embodiments, content management system can provide information about how users with which a content item is shared are interacting or have interacted with the content item. In some embodiments, content management system 110 can report that a user with which a content item is shared is currently viewing the content item. For example, client collaboration service 160 can notify notifications service 117 when client device 150 is accessing the content item. Notifications service 117 can then notify all client devices of other users having access to the same content item of the presence of the user of client device 150 with respect to the content item.

In some embodiments, content management system 110 can report a history of user interaction with a shared content item. Collaboration service 126 can query data sources such as metadata database 146 and server file journal 148 to determine that a user has saved the content item, that a user has yet to view the content item, etc., and disseminate this status information using notification service 117 to other users so that they can know who currently is or has viewed or modified the content item.

Collaboration service 126 can facilitate comments associated with content, even if a content item does not natively support commenting functionality. Such comments can be stored in metadata database 146.

Collaboration service 126 can originate and transmit notifications for users. For example, a user can mention another user in a comment and collaboration service 126 can send a notification to that user that he has been mentioned in the comment. Various other content item events can trigger notifications, including deleting a content item, sharing a content item, etc.

Collaboration service 126 can provide a messaging platform whereby users can send and receive instant messages, voice calls, emails, etc.

Collaboration Content Items

In some embodiments content management service can also include Collaborative document service 134 which can provide an interactive content item collaboration platform whereby users can simultaneously create collaboration content items, comment in the collaboration content items, and manage tasks within the collaboration content items.

Collaboration content items can be files that users can create and edit using a collaboration content item editor, and can contain collaboration content item elements. Collaboration content item elements may include a collaboration content item identifier, one or more author identifiers, collaboration content item text, collaboration content item attributes, interaction information, comments, sharing users, etc. Collaboration content item elements can be stored as database entities, which allows for searching and retrieving the collaboration content items. Multiple users may access, view, edit, and collaborate on collaboration content items at the same time or at different times. In some embodiments this can be managed by requiring two users access a content item through a web interface and there they can work on the same copy of the content item at the same time.

Collaboration Companion Interface

In some embodiments, client collaboration service 160 can provide a native application companion interface for the purpose of displaying information relevant to a content item being presented on client device 150. In embodiments wherein a content item is accessed by a native application stored and executed on client device 150, where the content item is in a designated location of the file system of client device 150 such that the content item is managed by client application 152, the native application may not provide any native way to display the above addressed collaboration data. In such embodiments, client collaboration service 160 can detect that a user has opened a content item, and can provide an overlay with additional information for the content item, such as collaboration data. For example, the additional information can include comments for the content item, status of the content item, activity of other users previously or currently viewing the content item. Such an overlay can warn a user that changes might be lost because another user is currently editing the content item.

In some embodiments, one or more of the services or storages/databases discussed above can be accessed using public or private application programming interfaces.

Certain software applications can access content storage 142 via an API on behalf of a user. For example, a software package such as an application running on client device 150, can programmatically make API calls directly to content management system 110 when a user provides authentication credentials, to read, write, create, delete, share, or otherwise manipulate content.

A user can view or manipulate content stored in a user account via a web interface generated and served by web interface service 124. For example, the user can navigate in a web browser to a web address provided by content management system 110. Changes or updates to content in the content storage 142 made through the web interface, such as uploading a new version of a content item, can be propagated back to other client devices associated with the user's account. For example, multiple client devices, each with their own client software, can be associated with a single account and content items in the account can be synchronized between each of the multiple client devices.

Task Service

Task service 136 can be configured to integrate with one or more third-party services to monitor third-party services for tasks created that pertain to a user account that is associated with a user that also has an account with content management system 110.

Client Device

Client device 150 can connect to content management system 110 on behalf of a user. A user can directly interact with client device 150, for example when client device 150 is a desktop or laptop computer, phone, television, internet-of-things device, etc. Alternatively or additionally, client device 150 can act on behalf of the user without the user having physical access to client device 150, for example when client device 150 is a server.

Some features of client device 150 are enabled by an application installed on client device 150. In some embodiments, the application can include a content management system specific component. For example, the content management system specific component can be a stand-alone client application 152, one or more application plug-ins, and/or a browser extension. However, the user can also interact with content management system 110 via a third-party application, such as a web browser, that resides on client device 150 and is configured to communicate with content management system 110. In various implementations, the client application 152 can present a user interface (UI) for a user to interact with content management system 110. For example, the user can interact with the content management system 110 via a file system explorer integrated with the file system or via a webpage displayed using a web browser application.

In some embodiments, client application 152 can be configured to manage and synchronize content for more than one account of content management system 110. In such embodiments, client application 152 can remain logged into multiple accounts and provide normal services for the multiple accounts. In some embodiments, each account can appear as folder in a file system, and all content items within that folder can be synchronized with content management system 110. In some embodiments, client application 152 can include a selector to choose one of the multiple accounts to be the primary account or default account.

While content management system 110 is presented with specific components, it should be understood by one skilled in the art, that the architectural configuration of system 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

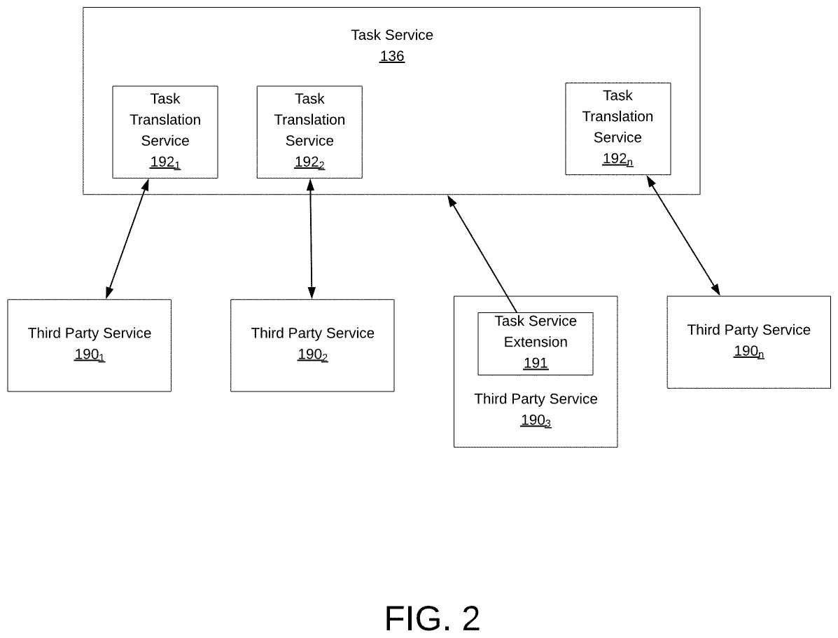

FIG. 2 illustrates task service 136 in greater details along with at least two mechanisms of interaction with third-party services 190 (190₁, 190₂, 190₃, and 190ₙ). Task service 136 can be configured to integrate with one or more third-party services to monitor third-party services for tasks created that pertain to a user account that is associated with a user that also has an account with content management system 110. While the present disclosure contemplates task service 136 as a service of content management system 110, nothing would prevent third-party service from being a standalone service that is separate from content management system 110. Any reference to task service 136 utilizing aspects of content management system 110 is by way of example only, and to the extent that task service 136 is implemented as a standalone service, similar functionality as referenced as being provided by content management system can be provided by analogous services that are specific to task service 136. No limitation on the task service should be implied based on cross reference between figures. The only limitations of task service 136 are those explicitly recited in the appended claims.

Third-party service 190 is a service to which task service 136 has no control, but to which data may be exchanged such as via application programming interfaces (APIs) or software development kits (SDKs) published by either or both of task service 136 or third-party service 190.

In some embodiments, task service 136 can include integrations with third-party services 190. In one type of integration, task service 136 can include a specific task translation service 192 for integrating with a specific third-party service 190. As shown in FIG. 2, task translation service 192₁ is specific to third-party service 190₁, task translation service 192₂ is specific to third-party service 190₂, and task translation service 192ₙ is specific to third-party service 190ₙ.

Task translation services 192 are each configured to understand and interpret tasks defined in its respective third-party service 190. Each third-party service 190 might represent or define tasks differently. Some third-party services 190 might define a task simply with a title in a document or project container. Some third-party services 190 might define tasks with titles, due dates, assigned parties, attached documents, etc. Task translation services 192 are configured to work with the respective application programming interfaces (APIs) or software development kits (SDKs) provided by the respective third-party services 190 to identify tasks and key data fields related to those tasks.

In a second type of integration with a third-party service 190, task service 136 can provide software code to be activated as an extension of task service 136 at a third-party service. For example, FIG. 2 illustrates task service extension 191 as an extension of task service 136 at third-party service 190₃. The extension can be used by a user to manually create tasks within task service 136 while viewing an application or webpage provided by third-party service 190₃. For example, task service interface 191 can be an extension to a web email service, or more generally, can be browser extension, and can be used to create tasks within task service 136 while the user is viewing their email on a webpage.

While FIG. 2 illustrates a third-party service 190 as utilizing either task translation services 192 or task service extensions 191 as a method of integration with task service 136, but multiple methods of integration can be utilized for the same service.

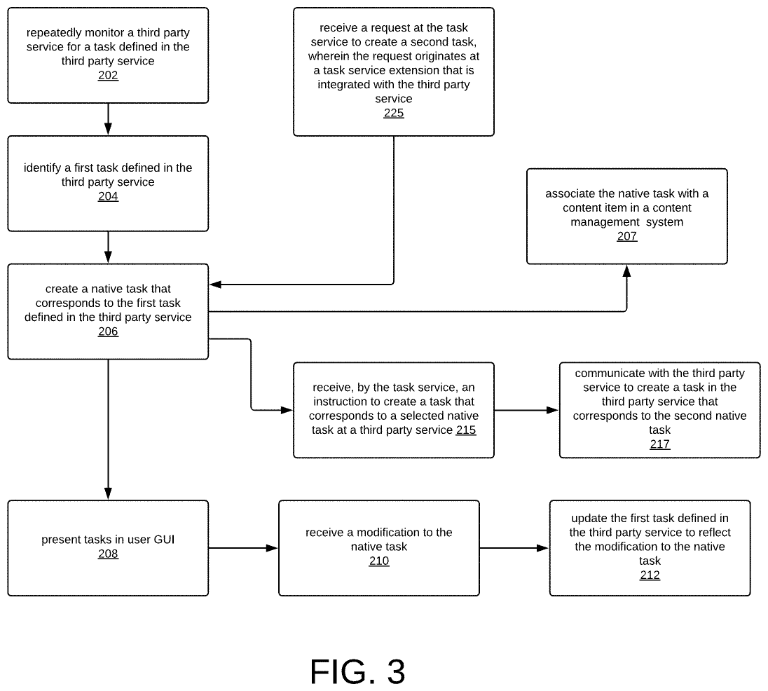

FIG. 3 illustrates an example method embodiment for creating and managing tasks by task service 136 in accordance with some aspects of the present technology.

As illustrated in FIG. 3, task service 136 can repeatedly monitor (202) a particular third-party service 190 via task translation service 192 specific to the particular third-party service 190 for a task defined in the third-party service 190. In some embodiments, task translation service 192 can have access to credentials to a user account for the user at the particular third-party service 190.

Task translation service 192 can utilize the credentials to the user account at the particular third-party service 190 to log into the particular third-party service and to identify (204) at least one task defined in the third-party service. As addressed above, task translation service 192 can be configured to understand the format and structure of tasks on the particular third-party service 190. When third-party service 190 supports identification of owners of tasks, or persons to whom a task is assigned, task translation service 192 can identify only tasks that are assigned to the user account—as these are the only tasks that are pertinent to the user. However, in some embodiments, a user can configure task translation service 192 to watch some tasks that are not actually assigned to that user. When third-party service 190 does not support identification of owners of tasks, task translation service 192 can identify (204) all tasks that are viewable by the user account, or all tasks in a project to which the user account is assigned.

For any task that task translation service 192 identifies as a task that should be represented in task service 136, task service 136 can create (206) a native task that corresponds to the task defined in third-party service 190. A native task, as that term is used herein refers to a task created by task service 136. A native task that corresponds to the task defined in the third-party service refers to a task created by task service 136 that is a representation of a task in a particular third-party service 190. The term native task differentiates tasks in task service 136 from tasks represented in third-party services 190. In some embodiments, the native task can include a link to the task it represents at third-party service 190.

Task service 136 can present (208) native tasks in a graphical user interface (GUI) where a user associated with a user account can browse native tasks, sort or filter native tasks, edit or modify native tasks, etc., as will be addressed further herein. For example, a user can provide an input into the graphical user interface to select a task and modify an aspect of the native task. Task service 136 can receive (210) the modification to the native task, and can update (212) the corresponding task defined at the third-party service that is represented by the native task to reflect the modification made to the native task. For example, a user can provide an input into the graphical user interface indicating that the task has been completed. Task service 136 can receive (210) this input, can mark the native task as completed, and can send a message (212) to the third-party service where the corresponding task is defined notifying the service to update (212) the task as completed.

FIG. 3 also illustrates some additional interactions that can be performed with respect to a native task. For example, task service 136 can associate (207) a selected native task with a content item in content management system 110 or other content management system. The content item to be associated with the native task could be identified by a user, or could be identified by task translation service 192 as a content item associated with the task in third-party service 190.

In some embodiments, task service 136 can be used to create a task in third-party service 190. Whether the native task in task service 136 was first created by task service 136 or was imported from a particular third-party service 190, the task service 136 can cause a task corresponding to the native task at task service 136 to be created at one of third-party services 190. Task service 136 can receive (215) an instruction to create a task at one of third-party services 136 that corresponds to an indicated native task. In response, task service 136 can communicate (217) with the third-party service 190 using task translation service 192 to create the task at third-party service 190.

While FIG. 3 has mostly addressed tasks that were first identified (204) at one of third-party services 190, tasks can also be created directly through an interface provided by task service 136 or through task service extension 191. Task service extension 191 is an extension of task service 136 that is accessible at third-party service 190₃. The extension can be used by a user to manually create tasks within task service 136 while viewing an application or webpage provided by third-party service 190₃. Task service 136 can receive (225) a request to create a task though task service extension 191 that is integrated with third-party service 190, and in response, can create (206) a native task.

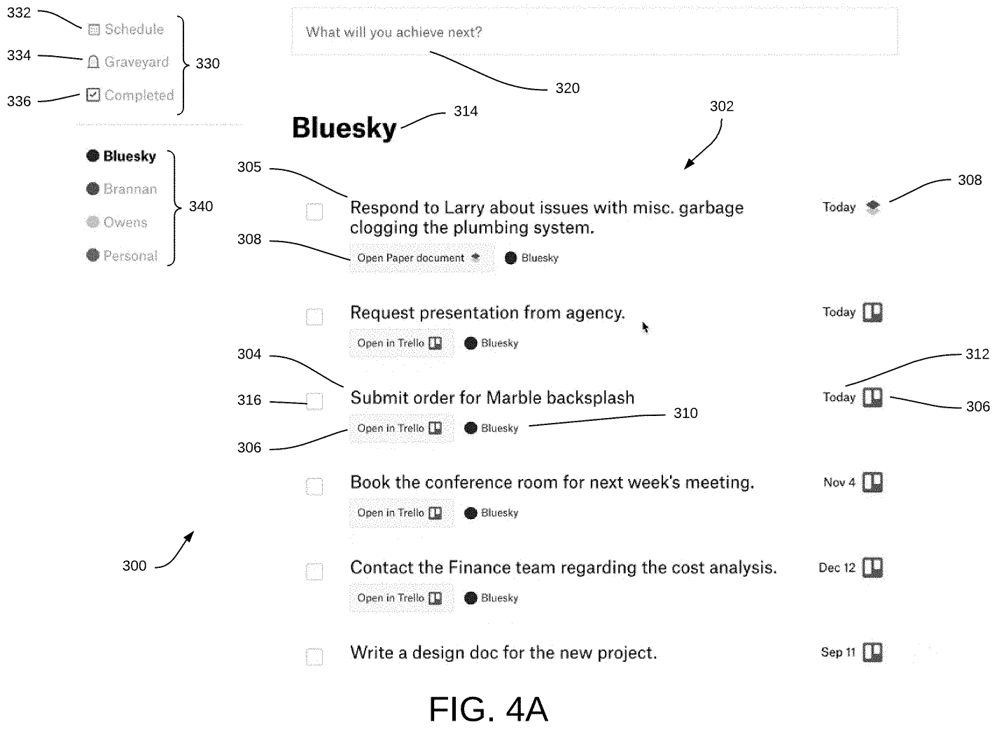

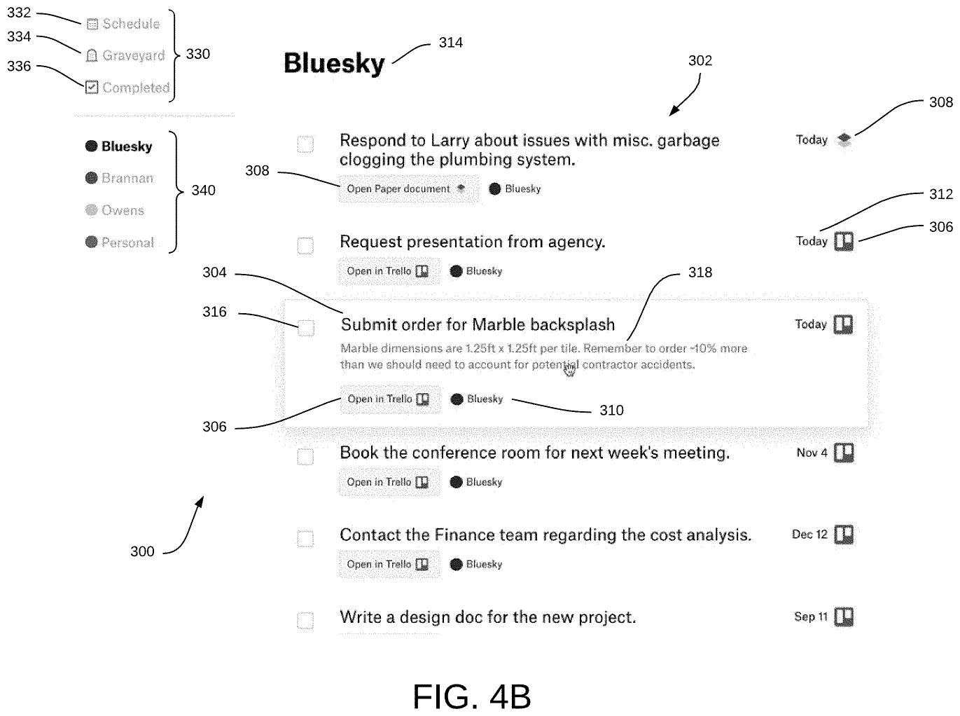

FIG. 4A and FIG. 4B illustrate an example graphical user interface presented by task service 136 and features thereof in accordance with some aspects of the present technology.

FIG. 4A illustrates graphical user interface 300, which can be presented by web interface services 124 and displayed in a web browser on client device 150, or can be presented and displayed by client application 152 on client device. While reference has been made to services and applications related to content management system 110, it will be appreciated that task service 136 can be a standalone service with its own web interface service and own client application.

Graphical user interface 300 can display a listing of native tasks 302 including example task 304. As discussed herein, native tasks 302 may be representative of tasks represented in third-party services 190. Graphical user interface can display icons or other information that is indicative of a particular third-party service where the task also exists. For example, graphical user interface 300 indicates that task 304 is located at a third-party workflow management application, TRELLO 306.

Native tasks 302 can also reside at other services that may have a first-party or second-party relationship to task service 136 (for example task service 136 could be a part of a larger entity including a third-party service, or could be in parent-subsidiary, or sibling company relationship with one another. For example, task 305 resides at cloud document service, PAPER 308. In such cases, task service 136 can interact with the first-party or second-party company in the same manner as described herein, or may even have deeper integrations and more privileged access.

When graphical user interface 300 receives a selection of one of the icons or other information that is indicative of a particular third-party service where the task also exists, task service 136 can open a webpage to that third-party service 190.

In some embodiments, while not shown, native tasks 302 can be displayed with a URL that links directly to the task in the third-party service 190.

In some embodiments, native tasks 302 can be associated with tags or labels, such as labels from project names. For example, task 304 is associated with project “Bluesky” and graphical user interface 300 includes a label 310 with the project name. In fact, in FIG. 4A all of the tasks are associated with project Bluesky as indicated by category heading 314. Other categories that might be selected are illustrated in grouping 330 that represents list filters, and grouping 340 that represents project filters.

Each native task 302 represented in graphical user interface 300 can also be associated with a date 312, which can be configured to be a due date for the task, a date in which the task is scheduled to be worked, at task creation date, or a last modified date.

Each native task 302 represented in graphical user interface 300 can also be associated with a check box 316 that, when selected, can be used to indicate that a task has been completed.

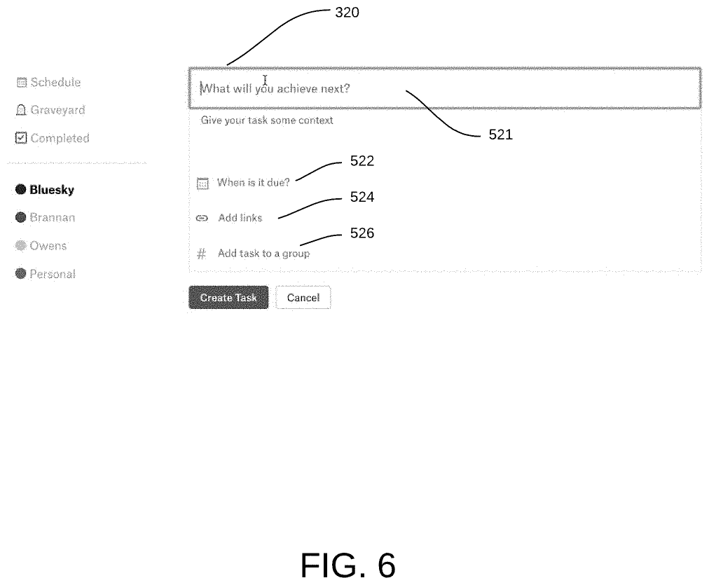

Graphical user interface 300 can also be used to create new tasks through task creation interface 320, which is addressed in greater detail with respect to FIG. 6.

List filters 330 can include a schedule filter 332 to display native tasks ordered by due date, or a date in which the tasks are scheduled to be worked on. Another filter is a graveyard filter 334, which can display old, but never completed tasks. Another filter is a completed task filter 336, which can display completed tasks. While not displayed, another filter could be a filter to display watched tasks that are not assigned to the user for their action. Additional filters can also be provided.

FIG. 4B illustrates an example of when a task is selected. For example, when task 304 is selected, task service 136 can expand the presentation of task 304 to display additional context 318. In some embodiments, the additional context can be a description of the task, comments associated with the task, other team members associated with the task, a due date, a hyperlink (e.g., a deep link) to the task a third-party service 190, a content item attached or linked to task 304, etc.

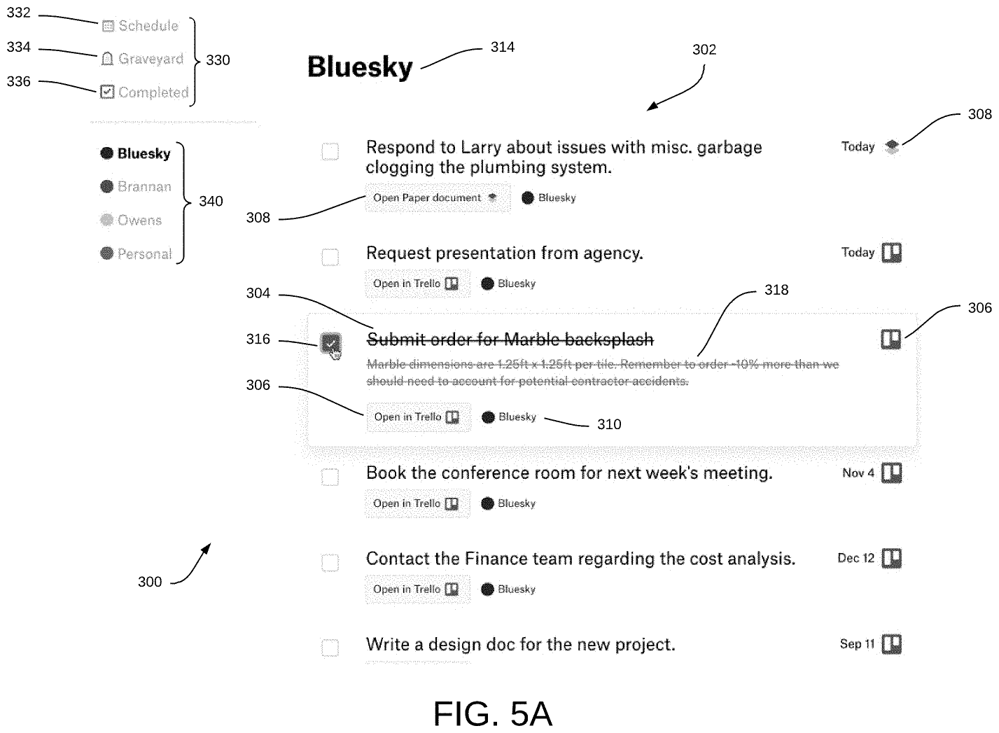

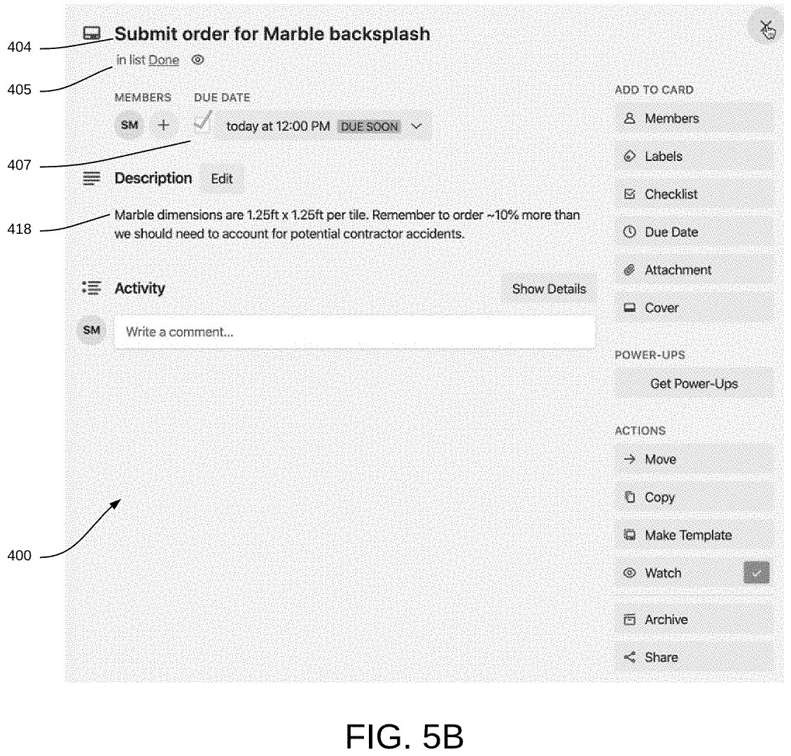

FIG. 5A illustrates a modification to the task at task service 136 and FIG. 5B illustrates that the modification can become automatically reflected in the task at the third-party service 190. For example, task service 136 can receive a user input in check box 316 corresponding to task 304 in graphical user interface 300, where the user input in check box 316 indicates that the task has been completed. As illustrated, graphical user interface 300 has been updated to reflect that task 304 has been completed by representing the task with a line through its text.

Correspondingly, FIG. 5B illustrates a graphical user interface 400 of third-party service 190 displaying the task 404 to which native task 304 represents. For example, native task 304 and task 404 share the same title and same context 318 and 418, respectively.

Each third-party service 190 may represent changes differently. In the example shown in FIG. 5B, third-party service 190 represents that task 404 has been moved to a list “done” 405 that is the home of completed tasks. A check mark 407 has also been represented next to the task's due date.

FIG. 6 illustrates an example task creation interface 320. Task creation interface 320 was also displayed in user interface 300 in FIG. 4A. Additionally, task creation interface 320 can also be displayed as part of task service extension 191. When task creation interface 320 is selected via a user input, it can be expanded as illustrated in FIG. 6. Task creation interface includes a field 521 to accept a name or context for the task, a date selector 522 to specify a due date, a link field 524 to link to a webpage, email, or content item associated the task, and a tag field 526 to specify tags that can be used to label, sort, and/or filter tasks.

In addition to being a single interface to represent all of a user's tasks in one place, the present technology can also include some intelligence regarding tasks to make managing tasks easier. Task service 136 can include heuristics or utilize machine learning to categorize and tag tasks, organize tasks, suggest tasks to be worked, etc.

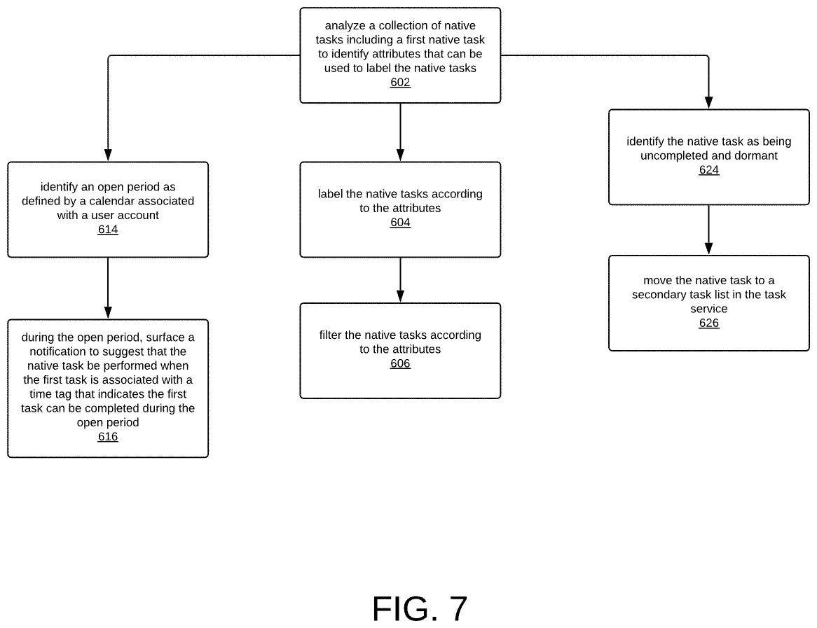

FIG. 7 illustrates some example method embodiments for making managing tasks easier in accordance with some aspects of the present technology. Whether by use of a programmed algorithm or heuristic, or with machine learning, task service 136 can analyze (602) a collection of native tasks to identify attributes that can be used to label the native tasks, and can label (604) the native tasks with appropriate attributes. Task service 136 can then utilize those labels to filter (606) native tasks.

Likewise, task service 136 can analyze (602) task to determine time related attributes such as an amount of time a particular task might take, or when a task should be worked on to meet a due date for that task and other tasks known to task service 136. This can be accomplished by a user providing a time table indicating approximate amounts of time certain types of task take. When tasks are labeled by type (by the user or identified via algorithm), task service can associate tasks with the indicated amount of time. In some embodiments, machine learning can be used to determine how long certain types of tasks take by monitoring a time between a click on a task where a user presumably gains some context, and the time the task is marked as completed. In some embodiments, task service 136 may be integrated with a time keeping software and can learn of times tasks take to complete.

Task service 136 can utilize these time determinations to identify (614) an open period on a calendar associated with the user account and can surface a notification (616) to suggest that the native task be worked on by the user when it is determined that the time associated with the task fits in an open period indicated by the calendar.

In some embodiments, task service 136 can also clean up tasks lists to remove clutter and help a user remained focused on the most important tasks. In some cases it has been observed that tasks that find their way on to task lists aren't necessarily completed, even when they are the top task on a list or overdue. Task service 136 can analyze (602) tasks to identify that a task has been on the task list for a while but is repeatedly ignored. In such cases, task service 136 can identify (624) the native task as dormant, and can move (626) the task to a task graveyard, which is a secondary task list for dormant tasks, or label the task as dormant so it is filtered from views showing active tasks.

In some embodiments, task service 136 can intelligently mark tasks as having been completed. For example, in embodiments wherein a content item has been associated with a native task, task service 136 may determine that activity has occurred with respect to the document and can mark the task as complete. For example, if native task has a title or context that indicates the function of the task is to review or edit a content item, task service 136 might assume that the task has been completed if it determines that the associated content item has be opened and closed or modified. In some embodiments, task service 136 could learn that a content item has been interacted with by interfacing with a content management system such as content management system 110. Task service 136 can identify a document as being associated with a task when the document is imported by task service 136 from third party service 190, or when a task references a document which task service 136 can identify in content management system 110. A user can also explicitly identify documents to be associated with tasks.

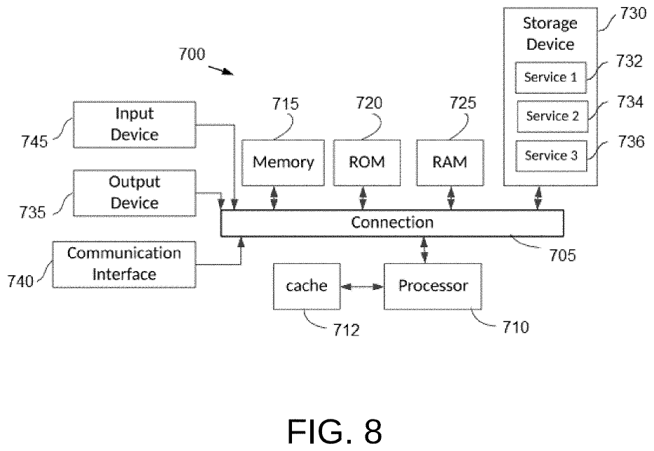

FIG. 8 shows an example of computing system 700, which can be for example any computing device making up client device 150, content management system 110, task service 136, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A non-transitory computer readable medium comprising instructions stored thereon, the instructions effective to cause at least one processor to:
repeatedly monitoring, by a task service, a third-party service for a task defined in the third-party service;
identify a first task defined in the third-party service; and
create, by the task service, a native task that corresponds to the first task defined in the third-party service.

2. The non-transitory computer readable medium of claim 1 comprising further instructions effective to cause the at least one processor to:
receive a modification to the native task; and
update, by the task service, the first task defined in the third-party service to reflect the modification to the native task.

3. The non-transitory computer readable medium of claim 1 comprising further instructions effective to cause the at least one processor to:
receive a request at the task service to create a second task, wherein the request originates in a task service interface that is integrated with the third-party service.

4. The non-transitory computer readable medium of claim 1 comprising further instructions effective to cause the at least one processor to:
identify a title of the first task and an identity of the third-party service;
when available, also identify context data for the first task such as a deadline for first task, a document associated with the first task, a link to the first task in the third-party service, and user accounts associated with the task in the third-party service,
wherein the creation of the native task corresponding to the first task includes creating the native task with the same title as the first task; and
presenting the native task in a user interface, wherein the presented native task identifies the third-party service, and when available identifies at least a portion of the context data.

5. The non-transitory computer readable medium of claim 4, wherein the identification of the title and the context data is performed by a task translation service that is configured to translate a data structure in the third-party service into a data structure of the task service.

6. The non-transitory computer readable medium of claim 1 comprising further instructions effective to cause the at least one processor to:
associate the native task with a content item in a content management system; and
automatically determine that the native task can be marked as completed when it is determined that activity has occurred in the content item in the content management system.

7. The non-transitory computer readable medium of claim 1 comprising further instructions effective to cause the at least one processor to:
analyze a collection of native tasks including a first native task to identify attributes that can be used to label the native tasks;
label the native tasks according to the attributes; and
filter the native tasks according to the attributes.

8. The non-transitory computer readable medium of claim 1 comprising further instructions effective to cause the at least one processor to:
identify the native task as being uncompleted and dormant; and
move the native task to a secondary task list in the task service.

9. The non-transitory computer readable medium of claim 1 comprising further instructions effective to cause the at least one processor to:
identify an open period as defined by a calendar associated with a user account; and
during the open period, surface a notification to suggest that the native task be performed when the first task is associated with a time tag that indicates the first task can be completed during the open period.

10. The non-transitory computer readable medium of claim 5 wherein the task translation service can receive a custom rule from a first user identifying custom contextual information to be stored with the native task.

11. The non-transitory computer readable medium of claim 1 comprising further instructions effective to cause the at least one processor to:
receive, by the task service, an instruction to create a second native task,
receive, by the task service, an instruction to export the second native task to a third-party service; and
communicate with the third-party service to create a task in the third-party service that corresponds to the second native task.

12. A method comprising:
receiving a request at a task service to create a native task, wherein the request originates from a task service interface that is integrated with a third-party service; and
creating the native task using information received in the request from the task service interface that is integrated with the third-party service.

13. The method of claim 12 further comprising:
associating the native task with a content item in a content management system; and
automatically determining that the native task can be marked as completed when it is determined that activity has occurred in the content item in the content management system.

14. The method of claim 12 further comprising:
analyzing a collection of native tasks including the native task to identify attributes that can be used to label the native tasks;
labeling the native tasks according to the attributes; and
filtering the native tasks according to the attributes.

15. The method of claim 12 further comprising:
identifying the native task as being uncompleted and dormant; and
moving the native task to a secondary task list in the task service.

16. The method of claim 12 further comprising:
receiving, by the task service, an instruction to create a second native task,
receiving, by the task service, an instruction to export the second native task to a third-party service; and
communicating with the third-party service to create a task in the third-party service that corresponds to the second native task.

17. A task service system comprising:
at least one non-transitory computer readable medium storing instructions; and
at least one processor configured to execute the instructions to cause the system to:
receive, by the task service system, a modification to a native task of the task service system; and
update, by the task service, a first task in a third-party service to reflect the modification to the native task, wherein the first task corresponds to the native task.

18. The system of claim 17 comprising further instructions effective to cause the at least one processor to:
identify a title of the first task and an identity of the third-party service;
when available, identify context data for the first task, the context data including at least one of: a deadline for first task, a content item associated with the first task, a link to the first task in the third-party service, and user accounts associated with the task in the third-party service,
wherein the creation of the native task corresponding to the first task includes creating the native task with the same title as the first task; and
presenting the native task in a user interface, wherein the presented native task identifies the service that is an origin of the native task, and when available identifies at least a portion of the context data.

19. The system of claim 17, wherein the instructions define a task translation service that is configured to translate a data structure in the third-party service into a data structure of the task service.

20. The system of claim 19 wherein the task translation service can receive a custom rule from a first user identifying custom contextual information to be stored with the native task.
